(19) United States
(12) Patent Application Publication
(10) Pub. No.: US 2026/0038168 A1
(43) Pub. Date: Feb. 5, 2026

(54) RECIPIENT-SIDE MODIFICATION OF VIDEOCONFERENCING CONTENT

(71) Applicant: NVIDIA Corporation, Santa Clara, CA (US)

(72) Inventor: Siddha Ganju, Santa Clara, CA (US)

(21) Appl. No.: 18/788,865

(22) Filed: Jul. 30, 2024

(51) Int. Cl. G06T 11/60; G06V 10/774; G06V 20/40

(52) U.S. Cl. CPC G06T 11/60; G06V 10/774; G06V 20/40; G06T 2200/24

(57) ABSTRACT

Disclosed are apparatuses, systems, and techniques for implementing recipient's control over displayed content received in videoconferencing applications. In one embodiment, the techniques include receiving, by a first processing device, media frames depicting participant(s) of a videoconference and generated by a sending processing device communicatively coupled to the first processing device over a network. The techniques further include processing, using a content recognition model, the media frames to identify auxiliary content in the media frames and replacing at least a portion of the identified auxiliary content with a replacement auxiliary content to generate a plurality of modified media frames. The techniques further include causing the modified plurality of media frames to be displayed using the first processing device or a second processing device.

### TECHNICAL FIELD

At least one embodiment pertains to processing resources and techniques used to execute and facilitate delivery of multimedia content. For example, at least one embodiment pertains to controlled modification of content delivered in videoconferencing communications.

### BACKGROUND

Videoconferencing technology is used in private conversations, business meetings, presentations, seminars, webinars, training sessions, and/or the like. A videoconferencing session can include any number of participants capable of receiving video and audio streams from other participants. The received streams are rendered on a display or some other graphical user interface of a participant's device. The graphical user interface can be segmented into multiple portions displaying the streamed multimedia content, e.g., small windows of equal size depicting various participants, a larger window rendering a stream from a presenting (or speaking) participant and displaying various materials, e.g., slides, provided by the presenting participant, and so on. Quality of the streamed multimedia (e.g., video and/or audio) content depends on the bandwidth and latency of the network connections of various participants, on the processing resources (e.g., CPUs, GPUs, memory, etc.) of the participants, and/or the like. The amount of information presented on the display of a given participant can be quite significant, with a variety of styles, backgrounds, tools, settings, etc., visible to the participant.

### BRIEF DESCRIPTION OF DRAWINGS

FIG. 1 is a block diagram of an example computing architecture capable of facilitating control over presentation of videoconferencing media content to a recipient of the content, according to at least one embodiment;

FIG. 2 illustrates schematically a data flow in an example videoconferencing system that facilitates recipient's control over presentation of streamed media content, according to at least one embodiment;

FIGS. 3A-3B illustrate schematically modification of a media frame performed by a receiving device, according to at least one embodiment;

FIG. 4 illustrates schematically a data flow in another example videoconferencing system with recipient's control, in which content classification occurs on a server device, according to at least one embodiment;

FIGS. 5A-5B illustrate schematically incremental identification of a content mask, according to at least one embodiment;

FIG. 6 depicts a flow diagram of an example method of controlling presentation of streamed media content by a recipient of videoconferencing services, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment.

### DETAILED DESCRIPTION

The existing videoconferencing applications typically offer some degree of customization to the participants. For example, a participant (user) can select a type of background to be streamed together with the video of the user's face, e.g., a blurred background, a background having a uniform color, a patterned background, an image selectable by the user, and/or some other custom background. The user can also control the amount of light or contrast applied to the user's image and/or a variety of other available image filters.

A degree of control available to the recipient of the stream(s) is typically significantly lower. For example, a recipient can block off a speaker's video feed if the recipient's network bandwidth is low and/or memory/processor usage is high. If the recipient has to watch the video feed (e.g., in the instances where a shared presentation is streamed), there can be no choice but to keep the video feed on the display. The displayed video, however, can have a background or other artifacts that are distracting to the recipient, e.g., a picture with bright or unusual colors, a background that is dynamic (changing with time), with people walking or other objects (e.g., cars) moving. Some recipients can have medical conditions (e.g., color blindness, astigmatism, color hypersensitivity, etc.) or psychological conditions (e.g., attention deficit/hyperactivity disorder, etc.) that make it difficult for the recipient to focus on the foreground and/or the content when various distracting artifacts are present. The existing techniques do not provide a significant degree of control over streamed content to the recipient of such content.

Aspects and embodiments of the instant disclosure address these and other technological challenges by disclosing systems and techniques that facilitate control of a recipient of videoconferencing media content over how the content is displayed on the recipient's display or other graphical user interface (GUI). More specifically, a media content, e.g., a stream of video frames generated during a videoconference, a video phone call, etc., can be processed by a trained content recognition (CR) model that classifies various units (e.g., pixels) of the frames as auxiliary content (which can be modified, in accordance with the recipient's preferences) or as primary content (which is to remain unmodified). For example, the CR model can output a binary map or mask m(x, y) of pixels of individual frames F(t₀) . . . F(tⱼ) with classifications of various pixels as auxiliary pixels (e.g., m=0) or primary content pixels (e.g., m=1), which can be based on probabilities that different pixels belong to one of such classes. The background (auxiliary) pixels may then be replaced with pixels of one of the backgrounds preferred by the recipient, e.g., selected at the time of videoconferencing software installation, prior to the start of the videoconference, during the videoconference, and/or at some other suitable time.

In some embodiments, classification of the pixels of the video frames may be performed on the recipient's side, e.g., with the CR model installed on the recipient's computer, which may be a desktop computer, a laptop computer, a smartphone, an in-vehicle computing system, a talking kiosk, a smart display, etc., and/or any other suitable device. In other embodiments, classification of the pixels of the video frames may be performed on a server, e.g., a cloud server providing the videoconferencing services. In yet other embodiments, a first portion of the CR model, e.g., a backbone portion, may be located on the server, while a second portion of the CR model, e.g., a classifier portion, may be installed on the recipient's computer. Likewise, in some embodiments, the replacement of the pixels may occur on the recipient's device, e.g., with the pixel classification performed either on the recipient's device or on the server. In other embodiments, the replacement of the background pixels may occur directly on the server, with the server streaming already modified video frames. In such embodiments, the user's preferences may be stored on the server or communicated to the server, from the recipient device, at or before the time of the videoconference.

In some embodiments, the CR model may be trained to output pixel classification masks m(t₀) . . . m(tⱼ) independently for separate frames. In some embodiments, the CR model may be trained to classify pixels using semantic associations captured (e.g., by attention blocks of the model) across different frames, such that the masks of the individual frames m(t₀), Δ(t₁) . . . Δ(tⱼ) include a representation of a change (“delta” Δ) indicative of temporal evolution of the classification masks of different (e.g., adjacent) frames, Δ(tⱼ)=m(x, y; tⱼ)−m(x, y; tⱼ₋₁). This reduces the amount of data needed to be generated and/or streamed over a network, as the delta Δ may be a small fraction of the full mask.

In some embodiments, similar techniques may be used for identification and modification of other streamed content, including primary content. For example, a recipient may have difficulty reading low-contrast fonts in a streamed presentation or fonts that strain eyes, e.g., white fonts on a black background or fonts that are too small. The trained CR model may be capable of classifying pixels of the video frames into text pixels and non-text pixels and adjusting colors of the text pixels according to the recipient's preferences, segmenting regions of text, and/or magnifying such regions (provided that this can be accomplished without occluding other primary content), and/or performing various other similar modifications.

The advantages of the disclosed techniques include, but are not limited to, facilitating user control over styles of presentation of videoconferencing content that improves perception of content by a recipient and reduces individualized distractions, discomforts, and sensitivities of users. As a result of the control exercised over the content presentation, a user's ability to view and comprehend the content improves significantly.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implementing one or more vision language models (VLMs), systems implementing one or more multi-modal language models, systems implemented at least partially using cloud computing resources, systems for performing generative AI operations, and/or other types of systems.

### System Architecture

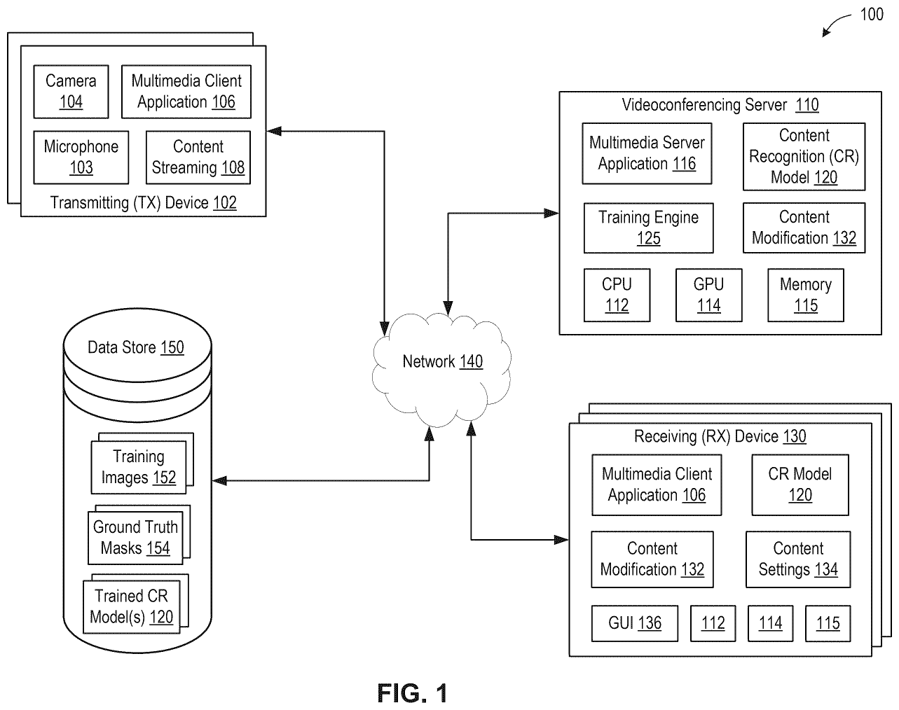

FIG. 1 is a block diagram of an example computing architecture 100 capable of facilitating control over presentation of videoconferencing media content to a recipient of the content, according to at least one embodiment. As depicted in FIG. 1, computing architecture 100 may include one or more transmitting (TX) devices 102, a videoconferencing server 110, one or more receiving (RX) devices 130, a data store 150, and/or other devices. TX device(s) 102 and/or RX device(s) 130 can include any suitable computing devices capable of providing videoconferencing support (including both hardware support and software support) to multiple participants of a videoconference. For example, any, some or all TX device(s) 102 and/or RX device(s) 130 may include a desktop computer, a laptop computer, a smartphone, a tablet computer, a server, a computing device that accesses a remote server, a computing device that utilizes a virtualized computing environment, a gaming console, a wearable computer, a smart TV, an automotive on-board computer, and/or the like. A TX device 102 may be a device that streams media data and an RX device 130 may be a device that receives the streamed data.

TX device 102 may include one or more multimedia devices, e.g., camera 104, microphone 103, speakers (not shown in FIG. 1), and/or the like. Camera 104 may be or include any suitable sensor capable of capturing and recording a time series of video frames, e.g., images of the environment faced by camera 104 and captured at a rate of 30 frames per second (fps), 60 fps, and/or any other suitable rate. Camera 104 may be a built-in camera, a camera that communicates with TX device 102 over a bus, a cable, a wireless connection, a personal area network (e.g., Bluetooth®) connection, and/or the like. Microphone 103 may be any suitable sensor capable of capturing and recording audio signals. Microphone 103 may be a sensor integrated into camera 104, a sensor integrated into TX device 102, a sensor communicatively coupled to TX device 102 (e.g., over a wired or wireless connection), and/or the like.

TX device 102 may support a multimedia client application 106 that facilitates content streaming 108 of video content captured by camera 104, audio content captured by microphone 103, and/or content generated by processing device(s)/memory of TX device 102, e.g., presentation slides. In some embodiments, multimedia client application 106 may facilitate videoconference operations on TX device 102. Multimedia client application 106 may be operating in conjunction with a multimedia server application 116 supported by videoconferencing server 110. In some embodiments, videoconferencing server 110 may be a cloud-based server operated by a videoconferencing service that serves, as client devices, TX device(s) 102 and RX device(s) 130.

Operations of videoconferencing server 110, TX device 102 (not explicitly illustrated for brevity), and RX device 130 may have any number of central processing units (CPUs) 112, graphics processing units (GPUs) 114, parallel processing units (PPUs), data processing units (DPUs), or accelerators, and/or other suitable processing devices capable of performing the techniques described herein. Videoconferencing server 110, TX device 102, and/or RX device 130 may further include any number of memory devices, also referred to simply as memory 115 herein. In some embodiments, any, some, or all of the videoconferencing server 110, TX device(s) 102, and/or RX device(s) 130 may further include network controllers, peripheral devices, scanners, printers, sensors, or any other devices configured for intake or output of data.

Videoconferencing server 110 may store executable codes, libraries, and various dependencies of multimedia server application 116 codes, libraries, and dependencies that support capturing multimedia data (e.g., video data and audio data), encoding multimedia data, packetizing encoded multimedia data, forwarding multimedia data to correct recipients of the data, depacketizing the received multimedia data, decoding the multimedia data, formatting the multimedia data for presentation using a display (and/or any other suitable GUI) and/or speakers of a user's computing device, and/or executing any number of operations supporting acquisition, streaming, and presentation of multimedia data. Videoconferencing server 110 may apportion the codes, libraries, and/or various dependencies between multimedia server application 116 and multimedia client applications 106 instantiated on various end devices, e.g., TX devices 102 and/or RX devices 130. For example, multimedia client applications 106 may perform encoding/decoding and packetizing/depacketizing of multimedia data while multimedia server application 116 may facilitate routing of data to correct recipients, enforcing authentication of data and data security measures, and so on.

Videoconferencing server 110 may deploy and/or make available to TX device(s) 102 and/or RX device(s) 130 a content recognition (CR) model 120 trained to classify various units (e.g., pixels or groups of pixels) of video frames generated by TX device(s) 102. Classification of units may be performed over any suitable set of classes. The classes may include a primary content class, including (but not limited to) faces of participants, content of materials being presented, and/or the like. The classes may further include an auxiliary content class, e.g., a background or various artifacts, such as frames, separation lines, menus, control buttons, and/or the like.

CR model 120 may be executed by CPU 112, GPU 114, and/or other processing devices, or any combination thereof. CPU 112 and/or GPU 114 (or other processing devices) may support any number of virtual CPUs and/or virtual GPUs. For example, GPU 114 may include multiple cores, each core being capable of executing multiple GPU threads. Each core may run multiple threads concurrently (e.g., in parallel). In at least one embodiment, threads may have access to registers. Some or all cores may include a scheduler to distribute computational tasks and processes among different threads of the respective core. A dispatch unit may implement scheduled tasks on appropriate threads using various private registers and shared registers. In at least one embodiment, GPU 114 may have a (high-speed) cache, access to which may be shared by multiple cores. Furthermore, GPU 114 may include a GPU memory to store intermediate and/or final results (outputs) of various computations performed by GPU 114.

CR model 120 may be or include one or more deep neural networks having one or more hidden layers, e.g., convolutional neural networks, recurrent neural networks, fully-connected neural networks, long short-term memory (LSTM) neural networks, neural networks with attention, e.g., transformer neural networks, language models (e.g., VLMs, multi-modal language models, etc.), and/or any other networks or a combination thereof. Various individual neurons of CR model 120 may receive inputs from other neurons or from an external source and may produce an output by applying a non-linear activation function to the sum of weighted (using trainable weights) inputs and, possibly, a bias value; the sum may then be used as an input into a non-linear activation function.

In some embodiments, CR model 120 may be trained by training engine 125. Training performed by training engine 125 may include supervised training, self-supervised training, unsupervised training, reinforcement training, and/or any other applicable training techniques. Initially, parameters (e.g., edge weights and biases) of CR model 120 may be assigned some starting (e.g., random) values. For various training images 152, training engine 125 may cause CR model 120 to generate training output(s). Training engine 125 may then compare training output(s) with the desired target output, e.g. ground truth masks 154 for training images 152. In some embodiments, ground truth masks 154 may include annotations (e.g., outlines, bounding boxes, and/or the like) indicating locations and/or boundaries between auxiliary content and primary content. The resulting error or mismatch between the target output(s) and the training output(s) may be backpropagated through various neuron layers of CR model 120, and the weights and biases of CR model 120 may be adjusted to bring the training outputs closer to the target outputs. This adjustment may be repeated until the output error for a given training image 152 (or a set of training images 152) satisfies a predetermined condition (e.g., falls below a predetermined value). Subsequently, a different training image 152 may be selected, new training output(s) generated, and a new series of adjustments implemented, until CR model 120 is trained to a target degree of accuracy or until CR model 120 reaches its architecture-limited accuracy. In some embodiments, training engine 125 may train multiple CR models 120 for different videoconferencing platforms, e.g., platforms provided by different vendors/developers.

In some embodiments, training images 152, ground truth masks 154, and/or other data may be stored in data store 150 accessible to videoconferencing server 110 via a bus, interconnect, network 140, and/or the like. Data store 150 may include persistent storage and may be hosted by one or more storage devices, such as main memory, magnetic or optical storage disks, tapes, or hard drives, network-attached storage (NAS), storage area network (SAN), and so forth. Although depicted as separate from videoconferencing server 110, in at least some embodiments, data store 150 may be a part of videoconferencing server 110. In at least some embodiments, data store 150 may be a network-attached file server, while in other embodiments, data store 150 may be some other type of persistent storage, such as an object-oriented database, a relational database, and so forth, that may be hosted by videoconferencing server 110 or one or more different machines coupled to videoconferencing server 110. Data store 150 may further store various trained CR models 120.

The trained CR models 120 may be downloaded and deployed on any suitable machine for classification and segmentation of multimedia content, e.g., videoconferencing server 110, RX device 130, and/or the like. RX device 130 may support multimedia client application 106 that facilitates connection of a user of RX device 130 to videoconferencing server 110, one or more TX devices 102, and/or one or more additional RX devices 130. Multimedia client application 106 can support scheduling a videoconference, starting a videoconference, joining a videoconference, transmitting and/or receiving a stream of video and/or audio data from a videoconference, recording a videoconference, and/or performing any other operation associated with the videoconference. In some embodiments, RX device 130 may receive a transmitted stream of video frames directly from TX device 102 (over network 140) or synchronized streams from multiple TX devices 102 at the same time. In some embodiments, RX device 130 may receive the stream of video frames transmitted from TX device(s) 102 indirectly, e.g., via videoconferencing server 110.

The stream of video frames received by RX device 130 may be processed by CR model 120 that classifies various pixels or groups of pixels of the received video frames as auxiliary content, primary content, and/or the like. Auxiliary content pixels may be replaced, by content modification stage 132, using content settings 134, which may include various preferences of the user of RX device 130. The modified content, which may include unmodified primary content and modified auxiliary content (e.g., background, artifacts, and/or the like), may be displayed on a GUI 136 to the user of RX device 130.

Although in the above embodiment, both content classification (by CR model 120) and content modification stage 132 are performed on RX device 130, in other embodiments, both content classification and content modification stage 132 may be performed on videoconferencing server 110. In yet other embodiments, content classification may be performed by CR model 120 operating on videoconferencing server 110 whereas content modification stage 132 may be performed on RX device 130.

In embodiments, the number of TX devices 102 and RX devices 130 need not be limited. It should be understood that a device may serve as TX device 102 that transmits a stream of data while simultaneously serving as RX device 130 that receives one or more streams of incoming multimedia data, e.g., generated by other TX device(s) 102.

In some embodiments, any, some, or all devices participating in a video conferencing session may be TX devices 102 and may transmit a video and/or audio stream that includes a video of a user of the respective device(s). In some embodiments, any number of devices participating in the video conferencing session may, at least temporarily, serve as RX devices 130 but not as TX devices 102. For example, a web-camera of a device may be stopped and/or a microphone of the device may be muted, so that the device does not stream (at that time) a live video feed and/or a live audio feed. In some instances, a device that is an RX device at some first time may be a TX device at some later (and/or earlier) second time. For example, a user listening to a presentation for a period of time may subsequently turn a web-camera on and ask a question or make a comment at some later time. Correspondingly, the user's device, which served as RX device 130 during the initial period of time, becomes TX device 102 during the later time (while also remaining an RX device that continues to receive video/audio stream(s) from other devices). At yet a later time, the user may again turn the video/audio off, and the user's device continues to serve as RX device 130.

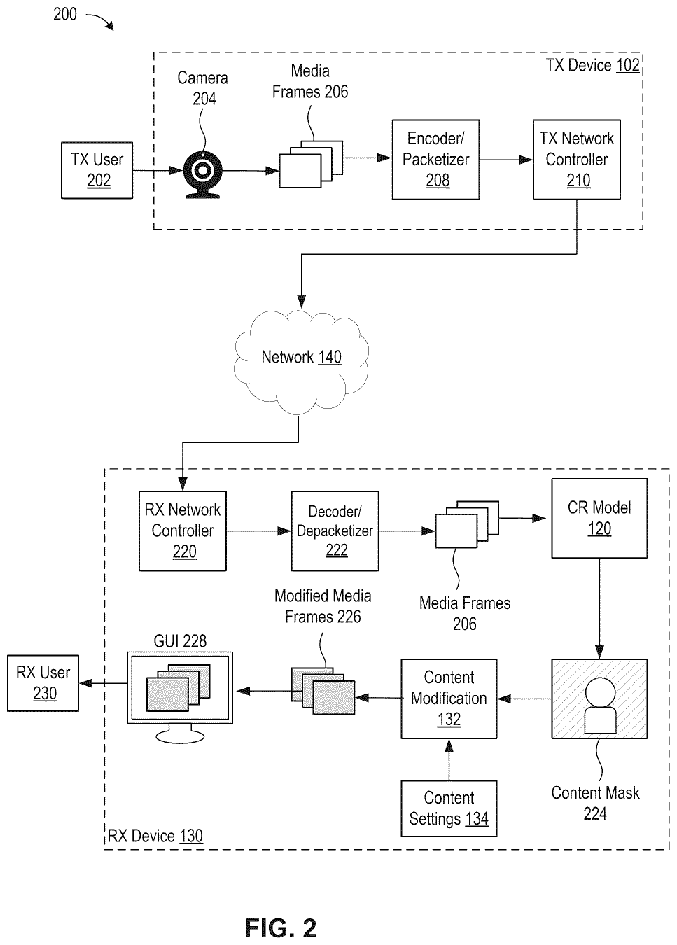

FIG. 2 illustrates schematically a data flow 200 in an example videoconferencing system that facilitates recipient's control over presentation of streamed media content, according to at least one embodiment. As depicted in FIG. 2, a user of TX device 102 (referred to as TX user 202 herein) can deploy and use any suitable teleconferencing software, e.g., multimedia client application 106 (referring to FIG. 1), to schedule, host, join, and/or otherwise participate in a teleconference with an RX user 230 of RX device 130. Media stream of TX user 202 may be produced using one or more cameras 204 (e.g., video cameras) that are built into TX device 102 or otherwise connected to TX device 102. Camera(s) 204 and/or other equipment (e.g., microphone(s)) may generate media frames 206, which may include video frames of any suitable pixel resolution and/or frame rate, e.g., 5-30 fps or any other suitable frame rate as may be set by TX user 202, camera 204 settings, and/or a teleconferencing software (e.g., default settings). Although FIG. 2 illustrates that the stream of media frames 206 is generated by camera(s) 204 (and/or microphone(s)), media frames 206 may be augmented or otherwise combined with any suitable content generated by various other programs and/or components of TX device 102, e.g., a slide presentation software, an image generation or presentation software, a word processing software, and/or the like. Various parts of the content may be rendered at different locations of media frames 206, e.g., non-overlapping locations or, in some instances, overlapping (e.g., partially overlapping) locations. TX user 202 may be provided some degree of control over the locations of the streamed content. For example, TX user 202 may select a location of a window displaying a video of TX user 202 within a presentation streamed by TX device 102. In some embodiments, TX user 202 may be able to select a background for media frames 206, e.g., a uniform background of a preferred color, a patterned background, a background that includes an image or a gallery of images (which displayed concurrently or sequentially, one-after-another), and/or the like. Media frames 206 may include audio data, e.g., a set of audio frames matching the video frames), capturing spoken words of TX user 202 and/or any other applicable sounds, e.g., ambient sounds, music, soundtracks, and/or any other audio signals.

Media frames 206 may be processed by an encoder/packetizer 208. In some embodiments, encoder/packetizer 208 may be a software-implemented encoder or a dedicated hardware-accelerated encoder that encodes individual media frames 206 by converting the frames from a raw video format to a suitable digital format (e.g., H.264 format). The encoded frames may be packetized for transmission over network 140. Packetizing the encoded frame may include partitioning the encoded frame into one or more packets (e.g., formatted units of data). A TX network controller 210 (network card, etc.) may transmit the packets via network 140 to an RX network controller 220 of RX device 130. Due to various network conditions, some of the packets associated with a specific media frame can be lost during transmission or take longer to be transmitted to the RX device 130. Depending on the embodiment, the lost packets may be recovered by RX device 130 (and/or TX device 102) using error correction techniques, transmission retries, or other suitable methods of packet transmission and/or retransmission.

RX device 130 may receive the packets that encode media frames 206 frames via RX network controller 220 connected to network 140. The received packets may be processed by a decoder/depacketizer 222 that depacketizes the packets to obtain encoded media frames and then decodes the frames to recover media frames 206. Decoder/depacketizer 222 may or include a software-implemented decoder or a dedicated hardware-accelerated decoder decoding data according to a specific media encryption standard used by encoder/packetizer 208.

Media frames 206 may be processed by a trained CR model 120. CR model 120 may include a ResNet neural network model, a U-Net model, a Vision Transformer model, a MobileNet model, or any other suitable neural network model, including but not limited to convolutional models, recurrent neural network models, LSTM neural networks, neural networks with attention (including self-attention), and/or the like. CR model 120 may output a content mask 224 that includes classification of various units (e.g., pixels or groups of pixels) x, y of media frames as auxiliary content, e.g., m=0, or as primary content, e.g., m=1. In some embodiments, more than two classes of pixels (units) may be defined for content mask 224, e.g., primary content, background, functional artifacts (e.g., buttons, frames, menus, etc.), and/or other applicable classes. CR model 120 may output a separate content mask 224, mⱼ(x, y), for separate media frames F(t₀) . . . F(tⱼ). In some embodiments, CR model 120 may output, for individual units, a probability p (x, y) that the individual unit x, y correspond to auxiliary content. The probability p (x, y) determined by a classifier layer of CR model (e.g., a sigmoid classifier, in the instances of binary classifications, or a softmax classifier, in the instance of more than two classes) to be above than a threshold probability p_{T}, e.g., p_{T}=0.5, 0.6, and/or the like, may indicate that the unit is to be classified as an auxiliary content unit.

Content mask 224 may be used by the content modification stage 132 that replaces auxiliary (e.g., background) pixels with pixels of one of the backgrounds that may be selected by RX user 230 and stored as part of content settings 134 to obtain modified media frames 226. Content settings 134 may be selected at the time of videoconferencing software installation, at the time of starting or joining the videoconference, during the videoconference, and/or at some other suitable time. Content settings 134 may include a color (e.g., hue), brightness, contrast, and/or any other visual parameters selected by the user, a type of background (e.g., uniform or patterned), an image or multiple images selected by the user, and/or the like.

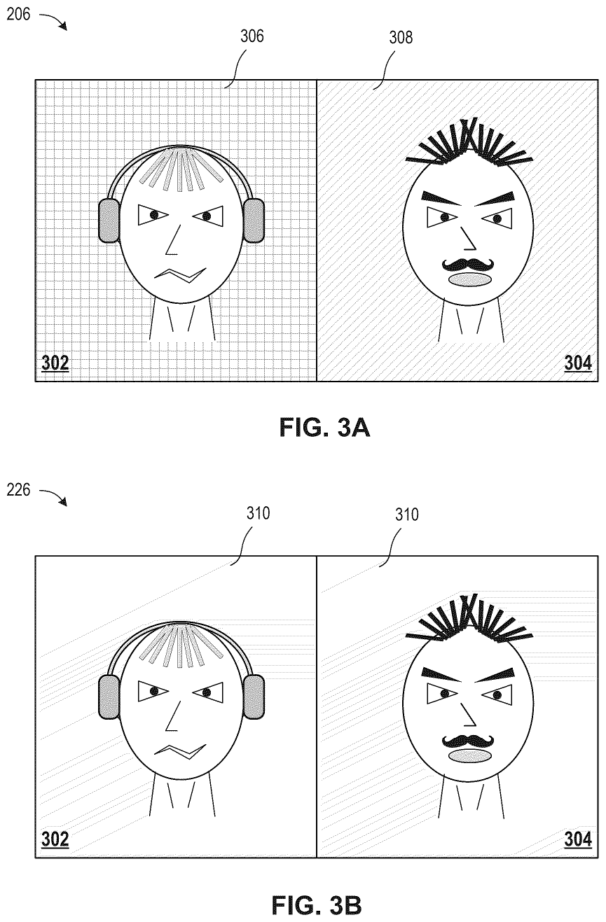

FIGS. 3A-3B illustrate schematically modification of a media frame performed by a receiving device, according to at least one embodiment. FIG. 3A depicts schematically a media frame 206 received from a TX device 102 (using nomenclature of FIG. 2) that includes a left portion 302 and a right portion 304, each portion displaying a corresponding video stream received from a TX device (an example non-limiting scenario of two video streams is illustrated). Left portion 302 includes background 306 and right portion 304 includes background 308. Backgrounds 306 and/or 308 may be TX user-selected backgrounds or default backgrounds selected by a videoconferencing software. Content modification stage 132 may identify pixels of backgrounds 306 and/or 308 (e.g., using content mask 224 generated by CR model 120) and select a replacement background 310, e.g., as identified by content settings 134. FIG. 3B depicts schematically a modified media frame 226 with the replacement background 310. Although in this example, the same replacement background 310 is applied to both portions of modified media frame 226, in some embodiments, different backgrounds may be applied to different portions of a frame.

Referring again to FIG. 2, modified media frames 226 may be displayed to RX user 230, e.g., via a display or any other suitable GUI 228, e.g., a smartphone screen, a TV, a headset, and/or the like.

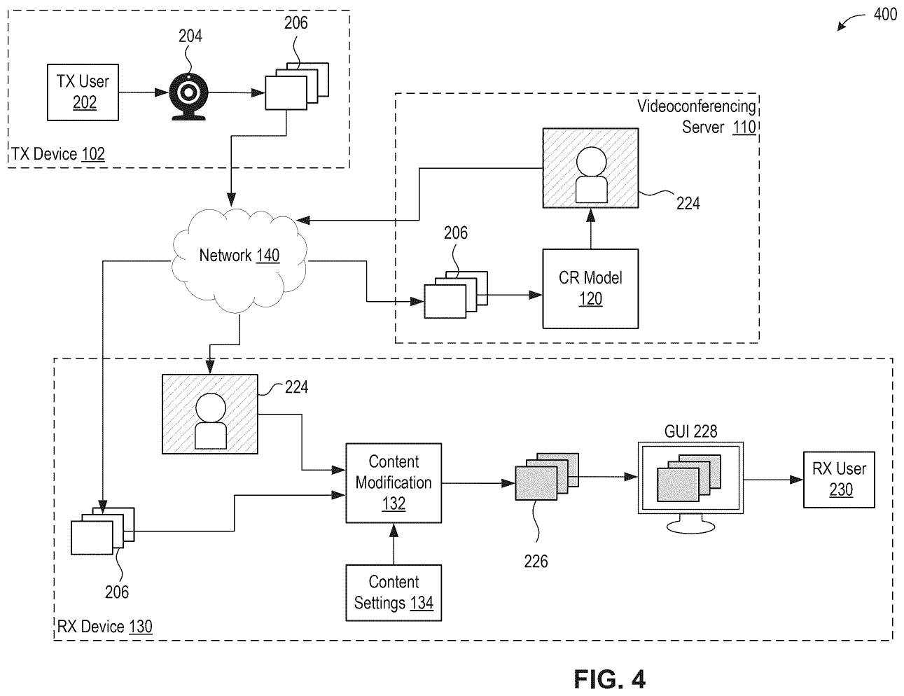

FIG. 4 illustrates schematically a data flow 400 in another example videoconferencing system with recipient's control, in which content classification occurs on a server device, according to at least one embodiment. As illustrated in FIG. 4, media frames 206 are provided from TX device 102 to both the RX device 130 and videoconferencing server 110. Videoconferencing server 110 deploys CR model 120 that generates content mask 224. Content mask 224 is then provided to RX device 130 together with media frames 206. Content modification stage 132 may then use content mask 224 and content settings 134 to generate modified media frames 226, e.g., as disclosed above in conjunction with FIG. 2. Modified media frames 226 may be displayed to RX user 230 via GUI 228.

Although not shown explicitly in FIG. 2 and FIG. 4, RX device 130 may concurrently receive multiple streams of media frames 226, from multiple TX devices 102. A decoder/depacketizer 222 (or some other module of RX device or videoconferencing server 110) may synchronize multiple incoming streams of media frames (e.g., using associated with the frames timestamps) and assemble the synchronized stream into a single video stream, which is then processed by CR model 120 and content modification 132. In some embodiments, individual incoming streams may be processed independently by CR model 120 and content modification 132 and subsequently combined for presentation on the GUI 228.

In other embodiments, classification of pixel units of the video frames may be performed jointly on videoconferencing server 110 and RX device 130, e.g., with a first portion of CR model 120, e.g., a backbone portion, operating on videoconferencing server 110, and a second portion of CR model 120, e.g., a classifier portion (a sigmoid classifier, a softmax classifier, and/or the like), may be operating on RX device 130.

In some embodiments, replacement of the pixels may be performed on RX device 130, e.g., as disclosed in conjunction with FIG. 2 and FIG. 4. In other embodiments, replacement of the pixels may be performed on videoconferencing server 110. In such embodiments, the user's preferences, e.g., content settings, may be stored directly on videoconferencing server 110 or communicated to videoconferencing server 110 by RX device 130, at or before the time of the videoconference.

In some embodiments, CR model 120 may generate a separate content mask m(t₀) . . . m(tⱼ) for each separate media frame F(t₀) . . . . F(tⱼ). In other embodiments, CR model 120 may be trained to output a sequence of transfer masks, e.g., Δ(t₁) . . . Δ(tⱼ), to minimize the amount of data generated and/or streamed over the network.

More specifically, CR model 120 may output a full content mask m(t₀) for the first frame F(t₀) and, for subsequent frames, generates transfer masks (differences), Δ(tⱼ)=m(x, y; tⱼ)−m(x, y; τ), characterizing changes in the content of a new frame F(tⱼ) relative to a reference frame F(t). In some embodiments, the reference frame may be the frame, e.g., τ=tⱼ₋₁, that immediately precedes frame F(tⱼ). In other embodiments, the reference frame may be a frame that is more than one frame removed from frame F(tⱼ), e.g., τ=tⱼ₋ₙ, where n>1. In some embodiments, frames F(t₀) . . . . F(tⱼ) that are processed by CR model 120 may include all media frames streamed by a TX device. In other embodiments, the frames F(t₀) . . . . F(tⱼ) may be a subset of all media frames streamed by the TX device, e.g., each Nth frame, where N may be an empirically selected value, e.g., N=2, 3, 4, 5, 10, and/or the like.

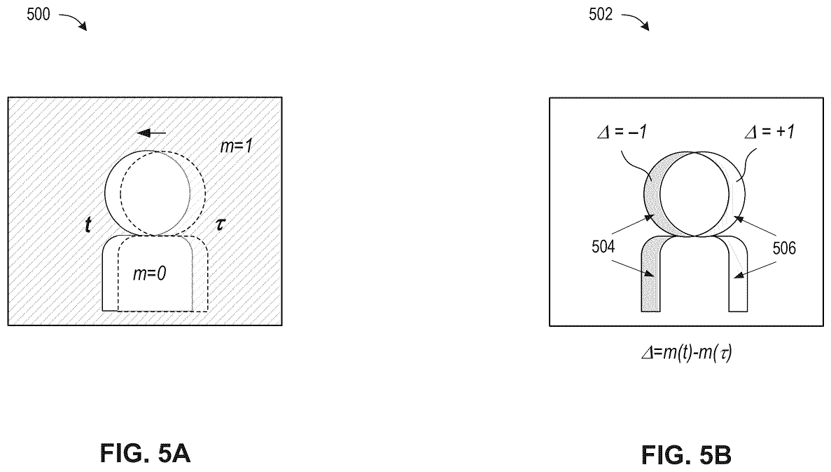

FIGS. 5A-5B illustrate schematically incremental identification of a content mask, according to at least one embodiment. FIG. 5A illustrates evolution 500 of media content between frames corresponding to times t and τ. The solid outline indicates the boundary between primary content, e.g., a picture of a TX user, and the auxiliary content (e.g., background) at time t, and the dashed outline indicates this boundary at an earlier time t. The auxiliary portion at time t is illustrated with the shading and the primary portion at time t is left white. FIG. 5B illustrates an example output 502 of CR model 120 that includes the white portion indicative of a region of a frame F(t) where no changes in the classification of content have occurred, relative to frame F(t), and the shaded portion indicative of a region where classification of the content has changed. More specifically, region 504 includes pixels whose classification has changed from m=1 (background) to m=0 (primary content) and region 506 includes pixels whose classification has changed from m=0 (primary content) to m=1 (background).

The disclosed techniques may be used for identification and modification of other streamed content, including primary content, in some embodiments. For example, the CR model or a dedicated text identification model may be trained to classify units (pixels and/or pixel groups) of media frames as text pixels and non-text pixels. The output of the text identification model may include regions of the media frames that contain text, e.g., alphanumeric characters. The CR model and/or a specialized optical character recognition (OCR) model may process the identified regions of the alphanumeric characters to recognize the characters and words, phrases, sentences, numbers, etc. Content modification stage 132 may then display the recognized words and/or numbers using user-preferred fonts, colors, and/or other parameters stored in content settings 134. In some embodiments, the recognized words and/or numbers may be magnified to a user-preferred size (e.g., also indicated in content settings 134) and placed in a vacant space within the presentation. In some embodiments, e.g., when the vacant space is absent and/or insufficient to fit the enlarged words and/or numbers, a user-controlled magnification tool (e.g., a virtual lens) can be used on the RX device side. More specifically, the RX user may use a pointing device to apply the magnification tool to a target region in the presentation and the content modification stage 132 may temporarily (e.g., while the magnification tool is being applied) enlarge words and/or numbers in the target region of the presentation (or any other part of the transmitted stream). This reduces a strain on the RX user's eyes and/or improves viewability of the content by users who have medical or psychological conditions that are detrimental for viewing media content having unusual backgrounds, colors, fonts, and/or any other artifacts.

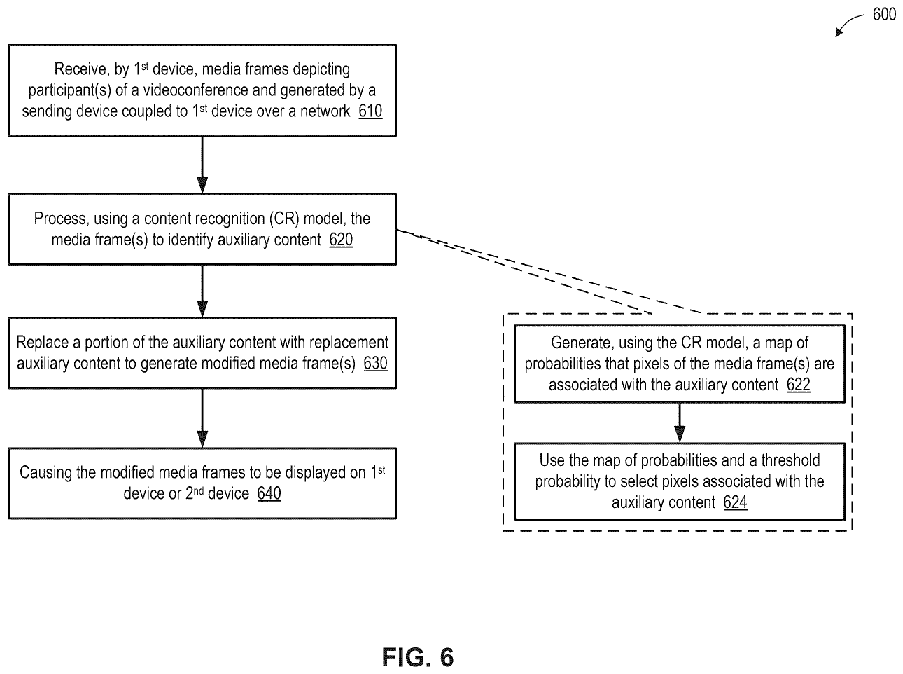

FIG. 6 depicts a flow diagram of an example method 600 of controlling presentation of streamed media content by a recipient of videoconferencing services, according to at least one embodiment. Method 600 may be performed to provision videoconferencing services in the context of business, communication, education, entertainment, pleasure, gaming, virtual reality, augmented reality, and/or any other context. Method 600 may be performed using one or more processing units (e.g., CPUs, GPUs, accelerators, PPUs, DPUs, etc.), which may include (or communicate with) one or more memory devices. In at least one embodiment, method 600 may be performed using various components and devices illustrated in FIG. 1, e.g., videoconferencing server 110, RX device 130, and/or any other suitable device. Method 600 may be performed to process data streamed by TX device 102 or multiple TX devices 102. In at least one embodiment, processing units performing method 600 may be executing instructions stored on a non-transient computer-readable storage media. In at least one embodiment, method 600 may be performed using multiple processing threads (e.g., CPU threads and/or GPU threads), individual threads executing one or more individual functions, routines, subroutines, or operations of the method. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

As illustrated in FIG. 6, method 600 may include, at block 610, receiving, by a first processing device, a plurality of media frames. The plurality of media frames may be generated by a sending processing device communicatively coupled to the first processing device over a network. In some embodiments, the first processing device may be or include a videoconferencing server 110. In some embodiments, the first processing device may be or include RX device 130. The plurality of media frames may depict one or more participants of a videoconference, e.g., TX user 202 in FIG. 2, and/or other participants, connecting to the videoconference using different devices.

At block 620, method 600 may continue with processing, using a content recognition (CR) model, the plurality of media frames to identify auxiliary content in the plurality of media frames. In some embodiments, the identified auxiliary content may include a background of at least one participant of the one or more participants of the videoconference.

In some embodiments, processing the plurality of media frames to identify the auxiliary content may include operations illustrated with the callout part of FIG. 6. More specifically, at block 622, operations of block 620 may include generating, using the CR model, for an individual media frame of the plurality of media frames, a map of probabilities characterizing a likelihood that graphical units (e.g., pixels or blocks of pixels) of the individual media frame are associated with the auxiliary content. At block 624, method 600 may continue with selecting, using the generated map of probabilities and a threshold probability, the graphical units of the individual media frame associated with the auxiliary content.

In some embodiments, the auxiliary content for an individual media frame of the plurality of media frames is identified relative to the auxiliary content for a reference media frame of the plurality of media frames (e.g., as disclosed in conjunction with FIG. 5). The reference media frame may precede the individual media frame.

In some embodiments, the CR model may be trained using training data that includes one or more training images. An individual training image of one or more training images may depict a background and a foreground that includes a subject (e.g., a person, participant). In some embodiments, the CR model includes a first portion located on a first processing device and a second portion located on a second processing device.

At block 630, method 600 may continue with replacing at least a portion of the identified auxiliary content with a replacement auxiliary content to generate a plurality of modified media frames. In some embodiments, the replacement auxiliary content is selected responsive to one or more configuration settings selected by a recipient of the modified plurality of media frames. The one or more configuration settings may be stored, prior to the commencement of the videoconference, on at least one of the first processing device or the second processing device.

At block 640, method 600 may continue with causing the modified plurality of media frames to be displayed using at least one of the first processing device or the second processing device. In some embodiments, e.g., when the first processing device includes RX device 130, the modified plurality of media frames may be displayed using a graphical user interface (GUI) of the first processing device. In other embodiments, e.g., when the first processing device includes a server processing device (e.g., videoconferencing server 110 communicatively coupled to the second processing device over the network), the modified plurality of media frames may be displayed using a GUI of a second processing device (e.g., RX device 130).

### Inference and Training Logic

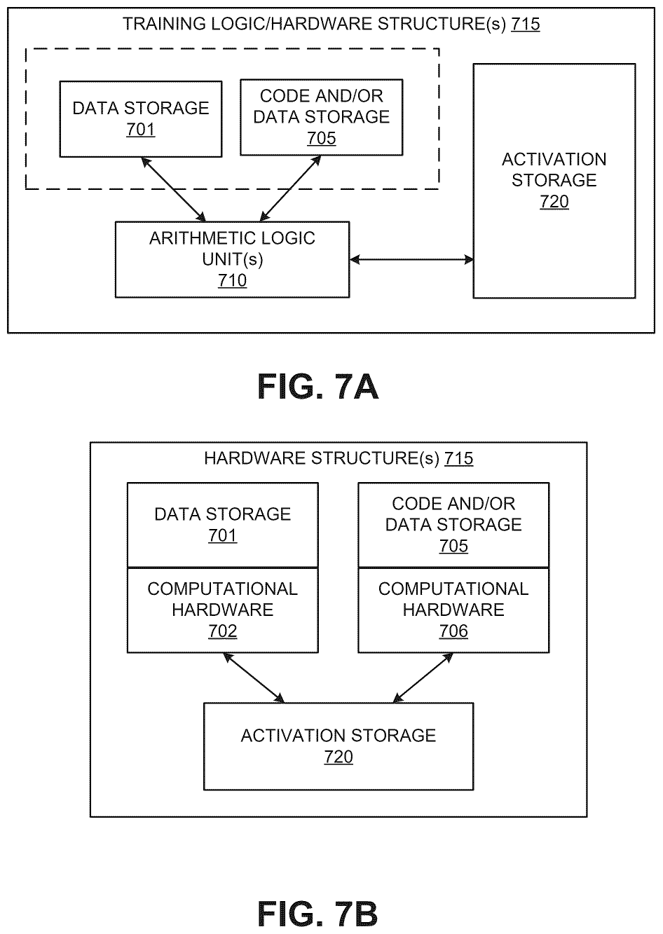

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

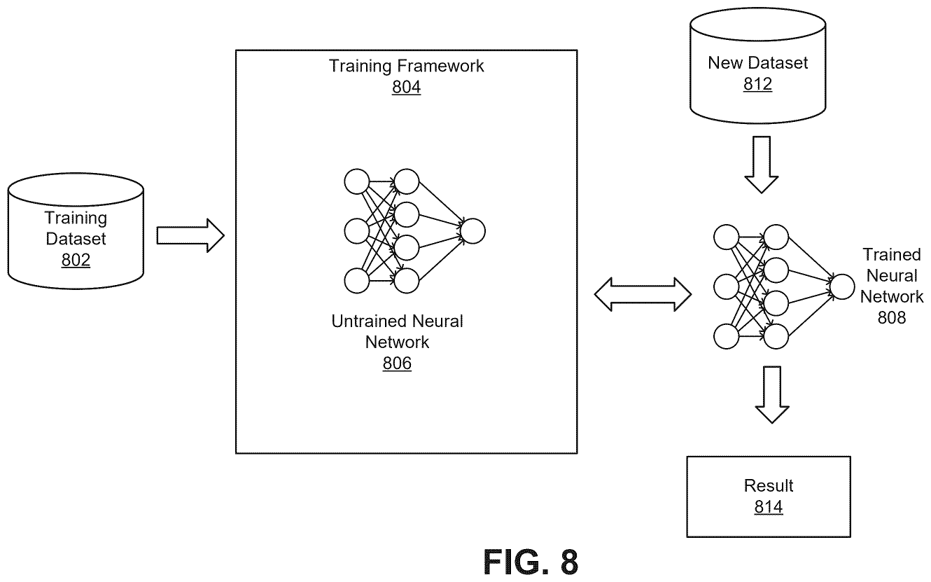

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

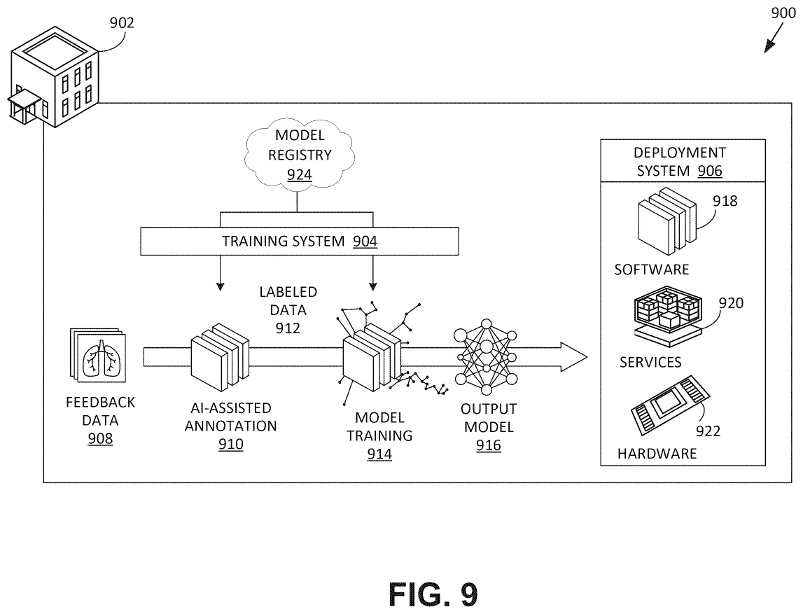

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

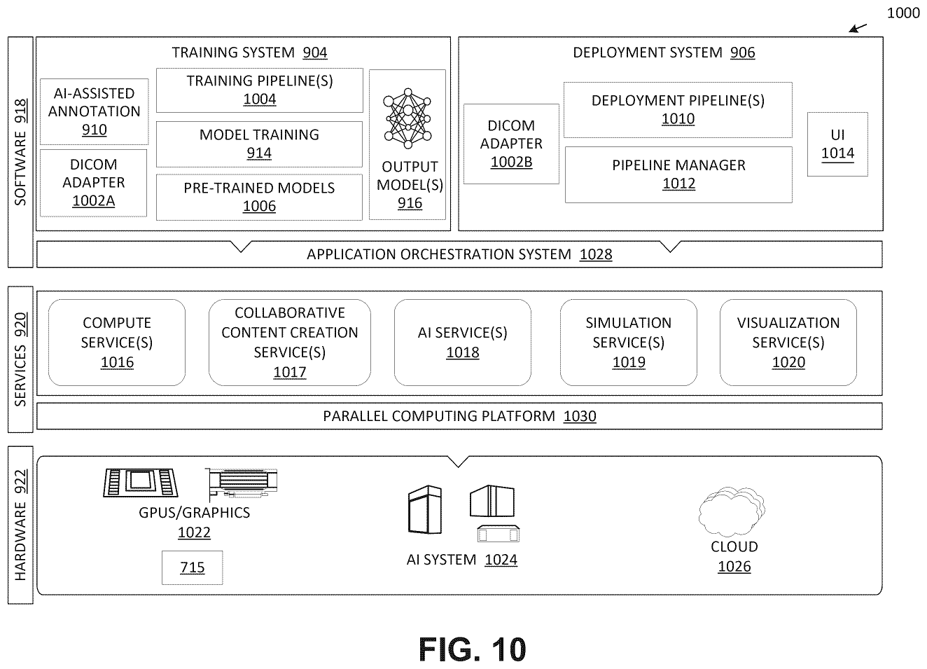

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, using a first processing device, a plurality of media frames, wherein the plurality of media frames are generated using a sending processing device that is communicatively coupled to the first processing device over a network, and wherein the plurality of media frames depict one or more participants of a videoconference;
processing, using a content recognition (CR) model, the plurality of media frames to identify auxiliary content in the plurality of media frames;
replacing at least a portion of the identified auxiliary content with a replacement auxiliary content to generate a plurality of modified media frames; and
causing the plurality of modified media frames to be displayed using at least one of:
the first processing device, or
a second processing device.

2. The method of claim 1, wherein the identified auxiliary content comprises a background of at least one participant of the one or more participants of the videoconference.

3. The method of claim 1, wherein the replacement auxiliary content is selected based at least on one or more configuration settings selected by a recipient of the plurality of modified media frames.

4. The method of claim 3, wherein the one or more configuration settings are stored, prior to a commencement of the videoconference, on at least one of the first processing device or the second processing device.

5. The method of claim 1, wherein the plurality of modified media frames is displayed using a graphical user interface (GUI) of the first processing device.

6. The method of claim 1, wherein the first processing device comprises a server processing device communicatively coupled to the second processing device over the network, and wherein causing the modified plurality of media frames to be displayed comprises:
causing the plurality of modified media frames to be displayed using a graphical user interface (GUI) of the second processing device.

7. The method of claim 1, wherein the processing the plurality of media frames to identify the auxiliary content comprises:
generating, using the CR model, for an individual media frame of the plurality of media frames, one or more probabilities characterizing a likelihood that graphical units of the individual media frame are associated with the auxiliary content; and
selecting, using the one or more generated probabilities and a threshold probability, the graphical units of the individual media frame associated with the auxiliary content.

8. The method of claim 1, wherein the auxiliary content for an individual media frame of the plurality of media frames is identified relative to the auxiliary content for a reference media frame of the plurality of media frames, wherein the reference media frame precedes the individual media frame.

9. The method of claim 1, wherein the CR model is trained using training data that comprises:
one or more training images, wherein an individual training image of one or more training images depicts:
a background, and
a foreground comprising a subject.

10. The method of claim 1, wherein the CR model comprises:
a first portion located on the first processing device, and
a second portion located on the second processing device.

11. A system comprising:
a first processing device to:
receive a plurality of media frames, the plurality of media frames being generated using a sending processing device communicatively coupled to the first processing device over a network, and the plurality of media frames depicting one or more participants of a video communication;
process, using a content recognition (CR) model, the plurality of media frames to identify auxiliary content in the plurality of media frames;
replace at least a portion of the identified auxiliary content with a replacement auxiliary content to generate a plurality of modified media frames; and
cause the plurality of modified media frames to be displayed.

12. The system of claim 11, wherein the identified auxiliary content comprises a background of at least one participant of the one or more participants of the video communication.

13. The system of claim 11, wherein the replacement auxiliary content is selected based at least on one or more configuration settings selected by a recipient of the modified plurality of media frames, and wherein the one or more configuration settings are stored, prior to a commencement of the video communication, on at least one of the first processing device or a second processing device.

14. The system of claim 11, wherein the plurality of modified media frames are displayed using a graphical user interface (GUI) of the first processing device.

15. The system of claim 11, wherein the first processing device comprises a server processing device communicatively coupled to a second processing device over the network, and wherein to cause the plurality of modified media frames to be displayed, the first processing device is to:
cause the plurality of modified media frames to be displayed using a graphical user interface (GUI) of the second processing device.

16. The system of claim 11, wherein to process the plurality of media frames to identify the auxiliary content, the first processing device is to:
generate, using the CR model and for an individual media frame of the plurality of media frames, a map of probabilities characterizing a likelihood that graphical units of the individual media frame are associated with the auxiliary content; and
select, using the generated map of probabilities and a threshold probability, the graphical units of the individual media frame associated with the auxiliary content.

17. The system of claim 11, wherein the auxiliary content for an individual media frame of the plurality of media frames is identified relative to the auxiliary content for a reference media frame of the plurality of media frames, wherein the reference media frame precedes the individual media frame.

18. The system of claim 11, wherein the CR model is trained using training data that comprises:
one or more training images, wherein an individual training image of one or more training images depicts:
a background, and
a foreground comprising a subject.

19. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data using AI operations;
a system incorporating one or more virtual machines (VMs);
a system implemented at least partially in a data center; or
a system implemented at least partially using cloud computing resources.

20. At least one processor comprising processing circuitry to modify at least a portion of a background of streamed video communication content based at least on user preferences stored in a memory of a device receiving the streamed video communication content.
